(19) United States
(12) Patent Application Publication
(10) Pub. No.: US 2020/0181532 A1
(43) Pub. Date: Jun. 11, 2020

(54) LIQUID HAND DISHWASHING CLEANING COMPOSITION

(71) Applicant: The Procter & Gamble Company, Cincinnati, OH (US)

(72) Inventors: Marc René Bert RENMANS, Strombeek-bever (BE); Stefano SCIALLA, Strombeek-bever (BE)

(21) Appl. No.: 16/691,638

(22) Filed: Nov. 22, 2019

(30) Foreign Application Priority Data
Dec. 5, 2018 (EP) 18210467.9

(51) Int. Cl. C11D 1/29; C11D 1/75; C11D 1/83; C11D 3/20; C11D 3/37; C11D 17/08

(52) U.S. Cl. CPC C11D 1/29; C11D 1/75; C11D 17/08; C11D 3/2068; C11D 3/3723; C11D 1/83

(57) ABSTRACT

The need for a liquid hand-dishwashing composition which provides further improved sudsing volume and longevity when washing dishware using diluted liquid hand dishwashing compositions, especially in the presence of greasy soil and particulate soil, while still providing the desired cleaning, is met when the composition is formulated with a surfactant system comprising an anionic surfactant and a co-surfactant, and poly(1,3-propyleneglycol).

### FIELD OF THE INVENTION

The present invention relates to a liquid hand dishwashing cleaning composition.

### BACKGROUND OF THE INVENTION

During manual dishwashing in a sink full of water into which a cleaning composition has been diluted, the user typically relies on the level of suds to indicate the remaining cleaning efficacy of the diluted cleaning composition. A high suds volume and/or stable, long-lasting suds longevity (i.e., mileage) indicates to the user that sufficient active ingredients (e.g., surfactants) remain, in order to perform the desired cleaning. Poor suds longevity typically leads to the user dosing additional cleaning composition even when cleaning efficacy remains.

Anionic surfactants have been used to provide suds during dishwashing, with alkyl sulfate and alkyl alkoxy sulfates having a high proportion of C12 and C13 chains being found to be particularly effective at providing improved sudsing in addition to the desired cleaning. Such sulphated surfactants can be derived from synthetic alcohols, such as OXO-alcohols and Fisher Tropsh alcohols. Fractionation can be used to increase the proportion of C12 and C13 alkyl chain. Alternatively natural derived alcohols rich in C12 and C14 chains or mixtures of natural and synthetic derived alcohols can be used as feedstock materials for sulphated surfactants. Alternatively sulphonated anionic surfactants or mixtures of sulphonated and sulphated anionic surfactants can also be used. These anionic surfactants are typically formulated together with co-surfactants, preferably selected from amphoteric, zwitterionic and optionally nonionic surfactants.

The suds volume and longevity are significantly affected by the presence of greasy or particulate soils, especially when high levels of both greasy and particulate soils are present in the dish-washing liquor. Often, methods of formulating to improve suds mileage in the presence of greasy soils leads to reduced suds mileage in the presence of particulate soils, and vice-versa.

Hence, there remains a need to further improve the sudsing volume and longevity when washing dishware using diluted liquid hand dishwashing compositions, especially in the presence of greasy soil and particulate soil, while still providing the desired cleaning.

U.S. Pat. No. 6,740,627B1 relates to detergent compositions comprising organic diamines, anionic surfactants and amphoteric surfactants including amine oxide for hand dishwashing which, by incorporating certain organic solvents, results in a liquid dishwashing detergent composition that is not only a more effective cleaning agent, but also offers improved physical and enzymatic stability and more convenient rheology and handling characteristics than typical liquid dishwashing compositions. EP2338961A1 relates to an alkaline liquid hand dish washing detergent composition. The composition comprises less than 80% water by weight of the composition and comprises hydrogen peroxide or a water-soluble source thereof or mixture thereof, an anionic surfactant or mixture thereof; an amine oxide surfactant or mixture thereof; a chelant or mixture thereof, and a free radial scavenger or mixture thereof. The composition can optionally comprise polypropyleneglycol as a solvent. JP2008184500A relates to liquid cleanser compositions for automatic dish washer, having a combination of low foamability with cleansing performance, the liquid cleanser composition comprising (a) 0.005-10 mass % of a nonionic surfactant, (b) 0.1-10 mass % of polypropyleneglycol, (c) a thickening agent and (d) water. US20100197553A1 relates to liquid hand dishwashing detergent composition comprising a cationic polymer and a humectant. Suitable humectants include polyethyleneglycol. WO2002077143 A relates to compositions suitable for use as a foaming hand dishwashing composition comprising a hydrophobic polymer having molecular weight of at least 500 and comprising butylene oxide moieties with the proviso that the composition does not comprise greater than 5% by weight of the composition of builder. WO2002077144 A relates to compositions comprising a hydrophobic polymer having molecular weight of at least 500 and comprising alkylene oxide moieties and a solvatrope comprising at least two polar groups separated by at least 4 aliphatic carbon atoms. WO2017011230 relates to a method of manually washing dishware comprising the steps of: delivering a detergent composition in its neat form onto the dishware or a cleaning implement; cleaning the dishware with the detergent composition in the presence of water; and optionally rinsing the dishware wherein the detergent composition comprises anionic surfactant and amine oxide surfactant in a ratio of from about 4:1 to about 1:1 and wherein the amine oxide surfactant comprises: from about 5% to about 40% by weight of the amine oxide of low-cut amine oxide of formula R1R2R3AO wherein R1 and R2 are selected from hydrogen, C1-C4 alkyls and mixtures thereof and wherein R3 is selected from C10 alkyls and mixtures thereof; and from 60% to 95% by weight of the amine oxide of mid-cut amine oxide of formula R4R5R6AO wherein R4 and R5 are selected from hydrogen, C1-C4 alkyls and mixtures thereof and wherein R6 is selected from C12-C16 alkyls and mixtures thereof and an amphiphilic alkoxylated polyalkyleneimine. WO2018017335 A relates to dishwashing detergent compositions comprising an anionic surfactant system comprising an average percentage of branching of greater than or equal to 5% to less than 24%; and at least one branched anionic surfactant derived from a 100% branched alcohol. WO2013016031 A relates to a multiphase liquid detergent composition comprising at least one cleaning phase and at least one benefit phase, a surfactant, and a crystalline structurant, the crystalline structurant being substantially present in a non-lamellar phase, and methods of cleaning dishware using such multiphase liquid detergent compositions. WO199800488 A relates to liquid dishwashing compositions which contain a surfactant system, a solvent to control viscosity, a hydrotrope to ensure appropriate solubility of the composition, and an effective amount of an anti-gelling polymer to inhibit gelling of the composition. WO201578743 A relates to surfactant-containing and salt-containing cleaning agent for hard surfaces in which the salt/surfactant concentration ratio ranges from 0.001 to 0.8 lasts longer during the use thereof. WO2008076693 A relates to compositions comprising a liquid portion comprising at least one surfactant and at least one material chosen from at least one suspending agent and at least one viscosity control agent, wherein the composition has an apparent viscosity under a shear stress of 0.5 Pa of at least about 1,000 Pa·s; and the composition has an apparent viscosity under a shear stress of 100 Pa of less than about 10 Pa·s., the composition is capable of suspending materials, but it still has desired rheological properties. WO2008092519 A relates to a surfactant combination of a fatty alcohol ether sulfate and a betaine used together with a viscosity-reducing ingredient in a concentrated manual dishwashing detergent, such that the use of anaerobically nondegradable surfactants which are obtained from nonrenewable raw materials can be dispensed with. EP0221774 A relates to high sudsing liquid detergent compositions contain anionic surfactant, polymeric surfactant which contains either linkages and a betaine surfactant for improved grease handling. US2005176614 A relates to a substantially transparent, liquid cleaning product for hard surfaces, comprising at least 15% by weight of a surfactant and one or more abrasive materials selected from the group consisting of polymers having a diameter of from 0.6 to 4 mm, natural materials having a diameter of from 0.05 to 4 mm, and mixtures thereof. WO200244312 A relates to a hand dishwashing composition includes from 0.1% to 90% of a sudsing surfactant, an effective amount of a suds suppresser, and the balance adjunct ingredients, As well as method for reducing the amount of water used during the rinsing step of a hand dishwashing process including the steps of providing the hand dishwashing composition, applying it to a dish and washware, wherein after the application step the dish comprises suds thereupon, and rinsing the suds from the dish with water.

### SUMMARY OF THE INVENTION

The present invention relates to a liquid hand dishwashing cleaning composition comprising: from 5% to 50% by weight of the total composition of a surfactant system, wherein the surfactant system comprises: an anionic surfactant selected form the group consisting of: alkyl sulfate, alkyl alkoxy sulfate, and mixtures thereof; and a co-surfactant selected from the group consisting of an amphoteric surfactant, a zwitterionic surfactant and mixtures thereof; and from 0.01% to 10% by weight of the composition of poly(1,3-propyleneglycol).

The present invention further relates to a method of manually washing dishware comprising the steps of: delivering the composition to a volume of water to form a wash solution and immersing the dishware in the solution, as well as to the use of the composition for the stabilization of suds in the presence of greasy and/or particulate soils.

### DETAILED DESCRIPTION OF THE INVENTION

The liquid hand dishwashing cleaning compositions of the present invention provide a good sudsing profile, including high suds volume generation and sustained suds stabilization through the dishwashing process, even when in presence of greasy and/or particulate soils. This signals to the user that there remains sufficient active ingredients present to provide continued cleaning performance, as such triggering less re-dosing and overconsumption of the product by the user.

The compositions of the present invention also provide good grease removal, in particular good removal of uncooked grease and particulate soils.

### Definitions

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present invention can comprise, consist of, and consist essentially of the essential elements and limitations of the invention described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high suds volume and/or sustained suds volume, particularly during a substantial portion of or for the entire manual dishwashing process. This is important as the consumer uses high suds as an indicator that sufficient cleaning composition has been dosed. Moreover, the consumer also uses the sustained suds volume as an indicator that sufficient active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

It is understood that the test methods that are disclosed in the Test Methods Section of the present application must be used to determine the respective values of the parameters of Applicants' inventions as described and claimed herein.

In all embodiments of the present invention, all percentages are by weight of the total composition, as evident by the context, unless specifically stated otherwise. All ratios are weight ratios, unless specifically stated otherwise, and all measurements are made at 25° C., unless otherwise designated.

### Cleaning Composition

The cleaning composition is a hand dishwashing cleaning composition in liquid form. The cleaning composition is preferably an aqueous cleaning composition. As such, the composition can comprise from 50% to 85%, preferably from 50% to 75%, by weight of the total composition of water.

Preferably, the pH of the composition is from about 6 to about 14, preferably from about 7 to about 12, or more preferably from about 7.5 to about 10, as measured at 10% dilution in distilled water at 20° C. The pH of the composition can be adjusted using pH modifying ingredients known in the art.

The composition of the present invention can be Newtonian or non-Newtonian, preferably Newtonian. Preferably, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof. The viscosity is measured with a Brookfield RT Viscometer using spindle 21 at 20 RPM at 25° C.

Poly(1,3-propyleneglycol)

The composition of the present invention comprises from 0.01% to 10% by weight of poly(1,3-propyleneglycol). The addition of poly(1,3-propyleneglycol) has surprisingly been found to be highly effective for maintaining sudsing in the presence of emulsified oily or greasy and/or particulate soils.

Since poly(1,3-propyleneglycol) consists of monomers of 1,3-propyleneglycol, having the structure: —(O—CH₂—CH₂—CH₂)—, poly(1,3-propyleneglycol) is linear, with no branching. In contyrast, poly(1,2-propyleneglycol) consists of monomers of 1,2-propyleneglycol, having the structure: —(O—CH₂—CH(CH₃))—. The poly(1,3-propyleneglycol) preferably comprises end-caps of hydrogen (H).

Relatively low levels of poly(1,3-propyleneglycol) have been found to be effective for maintaining suds in the presence of emulsified oils and grease and/or particulate soils. As such, the composition can comprise from 0.1% to 5.0%, preferably from 0.25 to 4.0%, more preferably from 0.5 to 3.0% of the poly(1,3-propyleneglycol).

Surprisingly low molecular weights of the poly(1,3-propyleneglycol) have been found to be effective for maintaining sudsing. As such, the composition can comprise the poly(1,3-propyleneglycol) having a weight average molecular weight of greater than 150 Da to less than 3000 Da, preferably from greater that 250 Da to less than 1,500 Da, more preferably from greater than 300 Da to less than 800 Da, even more preferably from greater than 350 Da to less than 600 Da.

Poly(1,3-propyleneglycol) can be obtained by the polymerization of 1,3-propanediol. For instance, polycondensation of 1,3-propanediol, or via catalysed ring opening polymerisation of oxetane. Suitable polymerisation methods have been described in: U.S. Pat. Nos. 6,977,291, 7,074,969, 6,720,459 and 7,074,968. Examples of suitable poly(1,3-propyleneglycol) include, but is not limited to, Velvetol H500, commercially available from Weylchem.

### Surfactant System

The cleaning composition comprises from 5% to 50%, preferably from 8% to 45%, most preferably from 15% to 40%, by weight of the total composition of a surfactant system. In order to improve surfactant packing after dilution and hence improve suds mileage, the surfactant system comprises an alkyl sulfate anionic surfactant and a co-surfactant. The co-surfactant is selected from the group consisting of an amphoteric surfactant, a zwitterionic surfactant and mixtures thereof. The alkyl sulfate anionic surfactant to the co-surfactant weight ratio can be from 1:1 to 8:1, preferably from 2:1 to 5:1, more preferably from 2.5:1 to 4:1.

### Anionic Surfactant

The surfactant system comprises from 60% to 90%, preferably from 65% to 85%, more preferably from 70% to 80% by weight of the surfactant system of alkyl sulfate anionic surfactant selected form the group consisting of: alkyl sulfate, alkyl alkoxy sulfate, and mixtures thereof.

Preferred alkyl alkoxy sulfates are alkyl ethoxy sulfates. The alkyl chain of the alkyl sulfate anionic surfactant preferably has a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 57/43, preferably from 60/40 to 90/10, more preferably from 60/40 to 80/20, most preferably from 60/40 to 70/30, while not compromising suds mileage in the presence of particulate soils.

The mol average alkyl chain length of the alkyl sulfate anionic surfactant can be from 8 to 18, preferably from 10 to 14, more preferably from 12 to 14, most preferably from 12 to 13 carbon atoms, in order to provide a combination of improved grease removal and enhanced speed of cleaning.

The relative molar amounts of C13 and C12 alkyl chains in the alkyl sulfate anionic surfactant can be derived from the carbon chain length distribution of the anionic surfactant. The carbon chain length distribution of the alkyl chains of the alkyl sulfate anionic surfactants can be obtained from the technical data sheets from the suppliers for the surfactant or constituent alkyl alcohol. Alternatively, the chain length distribution and average molecular weight of the fatty alcohols, used to make the alkyl sulfate anionic surfactant, can also be determined by methods known in the art. Such methods include capillary gas chromatography with flame ionisation detection on medium polar capillary column, using hexane as the solvent. The chain length distribution is based on the starting alcohol and alkoxylated alcohol. As such, the alkyl sulphate anionic surfactant should be hydrolysed back to the corresponding alkyl alcohol and alkyl alkoxylated alcohol before analysis, for instance using hydrochloric acid.

Preferably the alkyl sulfate anionic surfactant has an average degree of alkoxylation of less than 5, preferably less than 3, more preferably less than 2 and more than 0.5, most preferably from 0.5 to 0.9, in order to improve low temperature physical stability and improve suds mileage of the compositions of the present invention. The average degree of alkoxylation is the mol average degree of alkoxylation (i.e., mol average alkoxylation degree) of all the alkyl sulfate anionic surfactant. Hence, when calculating the mol average alkoxylation degree, the mols of non-alkoxylated sulfate anionic surfactant are included:

Mol average alkoxylation degree=(x1*alkoxylation degree of surfactant 1+x2*alkoxylation degree of surfactant 2+ . . . )/(x1+x2+ . . . )

wherein x1, x2, . . . are the number of moles of each alkyl (or alkoxy) sulfate anionic surfactant of the mixture and alkoxylation degree is the number of alkoxy groups in each alkyl sulfate anionic surfactant.

Preferred alkyl alkoxy sulfates are alkyl ethoxy sulfates

The alkyl sulfate anionic surfactant can have a weight average degree of branching of more than 10%, preferably more than 20%, more preferably more than 30%, even more preferably between 30% and 60%, most preferably between 30% and 50%. The alkyl sulfate anionic surfactant can comprise at least 5%, preferably at least 10%, most preferably at least 25%, by weight of the alkyl sulfate anionic surfactant, of branching on the C2 position (as measured counting carbon atoms from the sulfate group for non-alkoxylated alkyl sulfate anionic surfactants, and the counting from the alkoxy-group furthest from the sulfate group for alkoxylated alkyl sulfate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulfate surfactants having the aforementioned degree of branching results in improved low temperature stability. Such compositions require less solvent in order to achieve good physical stability at low temperatures. As such, the compositions can comprise lower levels of organic solvent, of less than 5.0% by weight of the cleaning composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

Weight average degree of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material before (alkoxylation and) sulfation to produce the alkyl (alkoxy) sulfate anionic surfactant. In the weight average degree of branching calculation, the weight of the alkyl alcohol used to form the alkyl sulfate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alcohol used to produce the alkyl sulfate anionic surfactant.

Suitable counterions include alkali metal cation earth alkali metal cation, alkanolammonium or ammonium or substituted ammonium, but preferably sodium.

Suitable examples of commercially available alkyl sulfate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of individual carbon chain lengths, preferably of C12 and C13 chains and the desired C13/C12 ratio, based on the relative fractions of C13 and C12 within the starting alcohols, as obtained from the technical data sheets from the suppliers or from analysis using methods known in the art.

The performance can be affected by the width of the alkoxylation distribution of the alkoxylated alkyl sulfate anionic surfactant, including grease cleaning, sudsing, low temperature stability and viscosity of the finished product. The alkoxylation distribution, including its broadness can be varied through the selection of catalyst and process conditions when making the alkoxylated alkyl sulfate anionic surfactant.

Without wishing to be bound theory, through tight control of processing conditions and feedstock material compositions, both during alkoxylation especially ethoxylation and sulfation steps, the amount of 1,4-dioxane by-product within alkoxylated especially ethoxylated alkyl sulphates can be kept minimal. A further reduction of 1,4-dioxane by-product can be achieved by a consequent 1,4-dioxane stripping, distillation, evaporation, centrifugation, microwave irradiation, molecular sieving or catalytic or enzymatic degradation step. Processes to control 1,4-dioxane content within alkoxylated/ethoxylated alkyl sulphates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)phenyl]-2 (1H)-pyridone, 3 a-hydroxy-7-oxo-mixture of cholanic acid, 3-(N-methyl amino)-L-alanine, and mixtures thereof. Tight 1,4-dioxane control across the raw material and detergent making process enables product formulations with remaining 1,4-dioxane content of below 10 ppm, preferably below 5 ppm, even more preferably below 1 ppm.

The surfactant system may comprise further anionic surfactant, including sulfonate such as HLAS, or sulfosuccinate anionic surfactants. However, the composition preferably comprises less than 30%, preferably less than 15%, more preferably less than 10% by weight of the surfactant system of further anionic surfactant. Most preferably, the surfactant system comprises no further anionic surfactant, other than the alkyl sulfate anionic surfactant.

### Co-Surfactant

The composition further comprises a co-surfactant selected from the group consisting of an amphoteric surfactant, a zwitterionic surfactant and mixtures thereof, as part of the surfactant system. The composition preferably comprises from 0.1% to 20%, more preferably from 0.5% to 15% and especially from 2% to 10% by weight of the cleaning composition of the co-surfactant.

The surfactant system of the cleaning composition of the present invention preferably comprises from 10% to 40%, preferably from 15% to 35%, more preferably from 20% to 30%, by weight of the surfactant system of a co-surfactant.

The co-surfactant is selected from the group consisting of an amphoteric surfactant, a zwitterionic surfactant, and mixtures thereof. The co-surfactant is preferably an amphoteric surfactant, more preferably an amine oxide surfactant.

The amine oxide surfactant can be linear or branched, though linear are preferred. Suitable linear amine oxides are typically water-soluble, and characterized by the formula R1—N(R2)(R3) 0 wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the invention can then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidoalkylbetaine, amidazoliniumbetaine, sulfobetaine (INCI Sultaines) as well as the Phosphobetaine, and preferably meets formula (I):

R¹—[CO—X(CH₂)ₙ]ₓ—N⁺(R²)(R³)—(CH₂)ₘ—[CH(OH)—CH₂]_{y}—Y⁻ (I)

Wherein in formula (I),

R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;

X is selected from the group consisting of: NH, NR⁴ wherein R⁴ is a C1-4 alkyl residue, O, and S, preferably NH,

n is an integer from 1 to 10, preferably 2 to 5, more preferably 3,

x is 0 or 1, preferably 1,

R2 and R3 are independently selected from the group consisting of: a C1-4 alkyl residue, hydroxy substituted such as a hydroxyethyl, and mixtures thereof, preferably both R2 and R3 are methyl,

m is an integer from 1 to 4, preferably 1, 2 or 3, most preferably 1

y is 0 or 1, preferably 0, and

Y is selected from the group consisting of: COO⁻, SO3⁻, OPO(OR5)O⁻ or P(O)(OR5)O⁻, preferably COO⁻ or SO3⁻, most preferably COO⁻, wherein R5 is H or a C1-4 alkyl residue.

Preferred betaines are the alkyl betaines of formula (Ia), the alkyl amido propyl betaine of formula (Ib), the sulfo betaines of formula (Ic) and the amido sulfobetaine of formula (Id):

R¹—N⁺(CH₃)₂—CH₂COO— (Ia)

R¹—CO—NH(CH₂)₃—N⁺(CH₃)₂—CH₂COO— (Ib)

R¹—N⁺(CH₃)₂—(CH₂)₃SO₃⁻ (Ic)

R¹—CO—NH(CH₂)₃—N⁺(CH₃)₂—(CH₂)₃SO₃⁻ (Ic)

in which R1 has the same meaning as in formula (I). Particularly preferred are the carbobetaines [i.e. wherein Y—=COO— in formula (I)] of formulae (Ia) and (Ib), more preferred are the alkylamidoalkylbetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Nonionic Surfactant:

### Alkoxylated Non-Ionic Surfactant:

Preferably, the surfactant system of the composition of the present invention further comprises from 1% to 25%, preferably from 1.25% to 20%, more preferably from 1.5% to 15%, most preferably from 1.5% to 5%, by weight of the surfactant system, of an alkoxylated non-ionic surfactant.

Preferably, the alkoxylated non-ionic surfactant is a linear or branched, primary or secondary alkyl alkoxylated non-ionic surfactant, preferably an alkyl ethoxylated non-ionic surfactant, preferably comprising on average from 9 to 15, preferably from 10 to 14 carbon atoms in its alkyl chain and on average from 5 to 12, preferably from 6 to 10, most preferably from 7 to 8, units of ethylene oxide per mole of alcohol.

### Alkyl Polyglucoside Nonionic Surfactant:

The compositions of the present invention can comprise alkyl polyglucoside (“APG”) surfactant. The addition of alkyl polyglucoside surfactants have been found to improve sudsing beyond that of comparative nonionic surfactants such as alkyl ethoxylated surfactants. If present, the alkyl polyglucoside can be present in the surfactant system at a level of from 0.5% to 20%, preferably from 0.75% to 15%, more preferably from 1% to 10%, most preferably from 1% to 5% by weight of the surfactant composition. Preferably the alkyl polyglucoside surfactant is a C8-C16 alkyl polyglucoside surfactant, preferably a C8-C14 alkyl polyglucoside surfactant. The alkyl polyglucoside preferably has an average degree of polymerization of between 0.1 and 3, more preferably between 0.5 and 2.5, even more preferably between 1 and 2. Most preferably, the alkyl polyglucoside surfactant has an average alkyl carbon chain length between 10 and 16, preferably between 10 and 14, most preferably between 12 and 14, with an average degree of polymerization of between 0.5 and 2.5 preferably between 1 and 2, most preferably between 1.2 and 1.6. C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

Suitable surfactant systems can comprise:
i) from 70% to 79% by weight of the surfactant system of an alkoxy ethoxy sulfate surfactant;
ii) from 20% to 30% by weight of the surfactant system of an amine oxide surfactant; and
iii) from 1% to 5% by weight of the surfactant system of an alkyl polyglucoside surfactant.

### Ethoxylated Vegetable Oil

The composition can further comprise ethoxylated vegetable oil having an average degree of ethoxylation of from 5 to 50, preferably from 10 to 40, more preferably from 15 to 30, most preferably 18 to 23. The addition of ethoxylated vegetable oil, especially ethoxylated castor oil having an average degree of ethoxylation of from 5 to 50, preferably from 10 to 40, more preferably from 15 to 30, most preferably 18 to 23, has been found to further improve suds mileage. This is especially surprising since the improvement in suds mileage from the addition of ethoxylated vegetable oil is minor without the presence of the poly(1,3-propyleneglycol). The ethoxylated vegetable oil can be present at a level of from 0.01 to 5.0%, preferably from 0.1 to 3.0%, more preferably from 0.2 to 2.0%, most preferably between 0.4 to 1.5%, by weight of the composition.

The ethoxylated vegetable oil can be made using one of several chemistries known to those skilled in the art such as base-catalyzed or acid-catalyzed ring-opening polymerization (for example, as described in U.S. Pat. Nos. 2,870,220, 2,133,480, or 2,481,278). The ethoxylation is typically carried out at 120-180° C. and 0-4 atmospheres using base-catalysts. Alternatively, hydroxyl-containing natural oils or hydroxyl-containing modified natural oils can be ethoxylated by reaction with an ethyleneglycol or a hydroxy-terminated oligo- and poly(ethyleneglycol) in the presence of a dehydration agent. Suitable reaction conditions are well-known in the art, for example, as described in U.S. Pat. No. 2,056,830 and EP 2 080 778.

Certain natural oils, such as castor oil, comprise triglycerides that contain hydroxylated fatty acids (e.g., ricinoleic acid) and may be ethoxylated without further modification. Other vegetable oils that do not contain sufficient quantities of hydroxylated fatty acids, but do contain unsaturated fatty acids may be modified to incorporate hydroxyl groups that can then be ethoxylated.

The ethoxylated vegetable oil can be derived from any suitable oil, such as those selected from the group consisting of: castor oil, soybean oil, peanut oil, sunflower oil, rapeseed oil, palm oil, cottonseed oil, groundnut oil, palm kernel oil, coconut oil, olive oil, corn oil, grape seed oil, linseed oil, sesame oil, maize oil, sesame oil, and mixtures thereof, though vegetable oils selected from the group consisting of: castor oil, soybean oil, sunflower oil, rapeseed oil, palm oil are preferred, with castor oil being most preferred.

The vegetable oil can be saturated or unsaturated, with saturated (i.e. fully hydrogenated) being preferred since processing of the ethoxylated castor oil into the composition is easier.

Suitable ethoxylated castor oils are commercially available from Clariant under the tradename Emulsogen EL200 (20 EO), from Sabic under the tradename Sabicol EL30 (30 EO).

### Amphiphilic Alkoxylated Polyalkyleneimine:

The composition of the present invention may further comprise from about 0.05% to about 2%, preferably from about 0.07% to about 1% by weight of the total composition of an amphiphilic polymer. Suitable amphiphilic polymers can be selected from the group consisting of: amphiphilic alkoxylated polyalkyleneimine and mixtures thereof. The amphiphilic alkoxylated polyalkyleneimine polymer has been found to reduce gel formation on the hard surfaces to be cleaned when the liquid composition is added directly to a cleaning implement (such as a sponge) before cleaning and consequently brought in contact with heavily greased surfaces, especially when the cleaning implement comprises a low amount to nil water such as when light pre-wetted sponges are used.

Preferably, the amphiphilic alkoxylated polyalkyleneimine is an alkoxylated polyethyleneimine polymer comprising a polyethyleneimine backbone having a weight average molecular weight range of from 100 to 5,000, preferably from 400 to 2,000, more preferably from 400 to 1,000 Daltons. The polyethyleneimine backbone comprises the following modifications:
(i) one or two alkoxylation modifications per nitrogen atom, dependent on whether the modification occurs at an internal nitrogen atom or at an terminal nitrogen atom, in the polyethyleneimine backbone, the alkoxylation modification consisting of the replacement of a hydrogen atom on by a polyalkoxylene chain having an average of about 1 to about 50 alkoxy moieties per modification, wherein the terminal alkoxy moiety of the alkoxylation modification is capped with hydrogen, a C1-C4 alkyl or mixtures thereof;
(ii) a substitution of one C1-C4 alkyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 50 alkoxy moieties per modification wherein the terminal alkoxy moiety is capped with hydrogen, a C1-C4 alkyl or mixtures thereof; or
(iii) a combination thereof.

For example, but not limited to, below is shown possible modifications to terminal nitrogen atoms in the polyethyleneimine backbone where R represents an ethylene spacer and E represents a C1-C4 alkyl moiety and X— represents a suitable water soluble counterion:

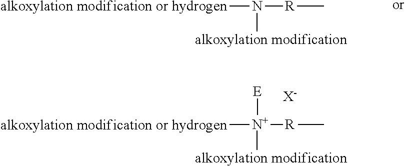

Also, for example, but not limited to, below is shown possible modifications to internal nitrogen atoms in the polyethyleneimine backbone where R represents an ethylene spacer and E represents a C₁-C₄ alkyl moiety and X— represents a suitable water soluble counterion:

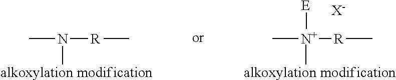

The alkoxylation modification of the polyethyleneimine backbone consists of the replacement of a hydrogen atom by a polyalkoxylene chain having an average of about 1 to about 50 alkoxy moieties, preferably from about 20 to about 45 alkoxy moieties, most preferably from about 30 to about 45 alkoxy moieties. The alkoxy moieties are selected from ethoxy (EO), propoxy (PO), butoxy (BO), and mixtures thereof. Alkoxy moieties solely comprising ethoxy units are outside the scope of use for the invention though. Preferably, the polyalkoxylene chain is selected from ethoxy/propoxy block moieties. More preferably, the polyalkoxylene chain is ethoxy/propoxy block moieties having an average degree of ethoxylation from about 3 to about 30 and an average degree of propoxylation from about 1 to about 20, more preferably ethoxy/propoxy block moieties having an average degree of ethoxylation from about 20 to about 30 and an average degree of propoxylation from about 10 to about 20.

More preferably the ethoxy/propoxy block moieties have a relative ethoxy to propoxy unit ratio between 3 to 1 and 1 to 1, preferably between 2 to 1 and 1 to 1. Most preferably the polyalkoxylene chain is the ethoxy/propoxy block moieties wherein the propoxy moiety block is the terminal alkoxy moiety block.

The modification may result in permanent quaternization of the polyethyleneimine backbone nitrogen atoms. The degree of permanent quaternization may be from 0% to about 30% of the polyethyleneimine backbone nitrogen atoms. It is preferred to have less than 30% of the polyethyleneimine backbone nitrogen atoms permanently quaternized. Most preferably the degree of quaternization is about 0%.

A preferred amphiphilic alkoxylated polyethyleneimine polymer has the general structure of formula (II):

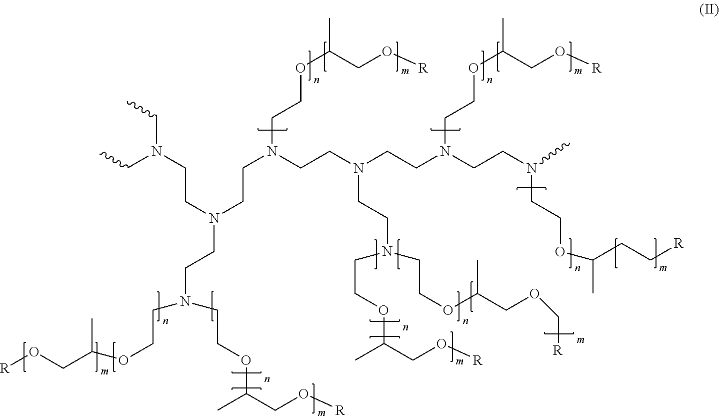

wherein the polyethyleneimine backbone has a weight average molecular weight of about 600, n of formula (II) has an average of about 10, m of formula (II) has an average of about 7 and R of formula (II) is selected from hydrogen, a C₁-C₄ alkyl and mixtures thereof, preferably hydrogen. The degree of permanent quaternization of formula (II) may be from 0% to about 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (II) but wherein the polyethyleneimine backbone has a weight average molecular weight of about 600 Da, n of Formula (II) has an average of about 24, m of Formula (II) has an average of about 16 and R of Formula (II) is selected from hydrogen, a C₁-C₄ alkyl and mixtures thereof, preferably hydrogen. The degree of permanent quaternization of Formula (II) may be from 0% to about 22% of the polyethyleneimine backbone nitrogen atoms, and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

### Cyclic Polyamine

The composition can comprise a cyclic polyamine having amine functionalities that helps cleaning. The composition of the invention preferably comprises from about 0.1% to about 3%, more preferably from about 0.2% to about 2%, and especially from about 0.5% to about 1%, by weight of the composition, of the cyclic polyamine

The amine can be subjected to protonation depending on the pH of the cleaning medium in which it is used. Preferred cyclic polyamines have the following Formula (III):

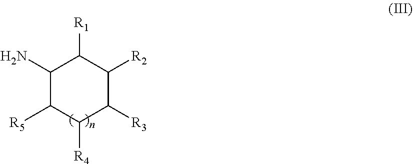

wherein R1, R2, R3, R4 and R5 are independently selected from the group consisting of NH2, —H, linear or branched alkyl having from about 1 to about 10 carbon atoms, and linear or branched alkenyl having from about 1 to about 10 carbon atoms, n is from about 1 to about 3, preferably n is 1, and wherein at least one of the Rs is NH2 and the remaining “Rs” are independently selected from the group consisting of NH2, —H, linear or branched alkyl having about 1 to about 10 carbon atoms, and linear or branched alkenyl having from about 1 to about 10 carbon atoms. Preferably, the cyclic polyamine is a diamine, wherein n is 1, R2 is NH2, and at least one of R₁, R₃, R₄ and R₅ is CH3 and the remaining Rs are H.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance

Accordingly, the most preferred cyclic polyamine for use with the cleaning composition of the present invention are cyclic polyamine selected from the group consisting of: 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present invention.

### Additional Ingredients:

The composition of the present invention may further comprise at least one active selected from the group consisting of: i) a salt, ii) a hydrotrope, iii) an organic solvent, and mixtures thereof.

### Salt:

The composition of the present invention may comprise from about 0.05% to about 2%, preferably from about 0.1% to about 1.5%, or more preferably from about 0.5% to about 1%, by weight of the total composition of a salt, preferably a monovalent or divalent inorganic salt, or a mixture thereof, more preferably selected from: sodium chloride, sodium sulfate, and mixtures thereof. Sodium chloride is most preferred.

### Hydrotrope:

The composition of the present invention may comprise from about 0.1% to about 10%, or preferably from about 0.5% to about 10%, or more preferably from about 1% to about 10% by weight of the total composition of a hydrotrope or a mixture thereof, preferably sodium cumene sulfonate.

### Organic Solvent:

The composition can comprise from about 0.1% to about 10%, or preferably from about 0.5% to about 10%, or more preferably from about 1% to about 10% by weight of the total composition of an organic solvent, beyond the poly(1,3-propyleneglycol) according the invention. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially poly(1,2-propyleneglycol), is the preferred glycol. The composition can comprise a mixture of poly(1,2-propyleneglycol) and poly(1,3-propyleneglycol).

### Adjunct Ingredients

The cleaning composition may optionally comprise a number of other adjunct ingredients such as builders (preferably citrate), chelants, conditioning polymers, other cleaning polymers, surface modifying polymers, structurants, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

### Method of Washing

The invention is further directed to a method of manually washing dishware with the composition of the present invention. The method comprises the steps of delivering a composition of the present invention to a volume of water to form a wash solution and immersing the dishware in the solution. The dishware is be cleaned with the composition in the presence of water. Optionally, the dishware can be rinsed. By “rinsing”, it is meant herein contacting the dishware cleaned with the process according to the present invention with substantial quantities of appropriate solvent, typically water. By “substantial quantities”, it is meant usually about 1 to about 20 L, or under running water.

The composition herein can be applied in its diluted form. Soiled dishware are contacted with an effective amount, typically from about 0.5 mL to about 20 mL (per about 25 dishes being treated), preferably from about 3 mL to about 10 mL, of the cleaning composition, preferably in liquid form, of the present invention diluted in water. The actual amount of cleaning composition used will be based on the judgment of the user, and will typically depend upon factors such as the particular product formulation of the cleaning composition, including the concentration of active ingredients in the cleaning composition, the number of soiled dishes to be cleaned, the degree of soiling on the dishes, and the like. Generally, from about 0.01 mL to about 150 mL, preferably from about 3 mL to about 40 mL of a cleaning composition of the invention is combined with from about 2,000 mL to about 20,000 mL, more typically from about 5,000 mL to about 15,000 mL of water in a sink. The soiled dishware are immersed in the sink containing the diluted cleaning compositions then obtained, before contacting the soiled surface of the dishware with a cloth, sponge, or similar cleaning implement. The cloth, sponge, or similar cleaning implement may be immersed in the cleaning composition and water mixture prior to being contacted with the dishware, and is typically contacted with the dishware for a period of time ranged from about 1 to about 10 seconds, although the actual time will vary with each application and user. The contacting of cloth, sponge, or similar cleaning implement to the dishware is accompanied by a concurrent scrubbing of the dishware.

The compositions described herein can also be used for direct application, whereby the composition is applied undiluted directly to the washware or on to an implement such as a damp sponge before being applied to the dishware.

Another aspect of the present invention is directed to use of a hand dishwashing cleaning composition of the present invention for providing good sudsing profile, including suds stabilization in the presence of greasy and/or particulate soils.

### Test Methods

The following assays set forth must be used in order that the invention described and claimed herein may be more fully understood.

### Test Method 1: pH Measurement

The pH is measured on the composition after dilution to 10% by weight in deionised water, at 20° C., using a Sartorius PT-10P pH meter with gel-filled probe (such as the Toledo probe, part number 52 000 100), calibrated according to the instructions manual.

### Test Method 2: Weight Average Molecular Weight

Unless otherwise specified, the weight average molecular mass for polymers is determined by gel permeation chromatography (GPC), preferably using GPC-LS (light scattering), such as the G1260 Infinity II Multi-Detector GPC/SEC System from Agilent Technologies. For water-soluble polymers, water can be used as a solvent (with the addition of methanol as needed up to 50% by weight), using an Agilent PL aquagel-OH column. For non-aqueous polymers, toluene can be used as a solvent, using an Agilent PLgel column.

### Test Method 3: Suds Mileage

The objective of the Suds Mileage Test is to compare the evolution over time of suds volume generated for the test formulations at various water hardness, solution temperatures and formulation concentrations, while under the influence of periodic additions of soil. Data are compared and expressed versus a reference composition as a suds mileage index (reference composition has a suds mileage index of 100). The steps of the method are as follows:
1. A rectangular metal blade having a horizontal length of 100 mm and vertical height of 50 mm is positioned in a sink having dimension of circa 300 mm diameter and circa 300 mm height, such that the blade is positioned centrally in the sink, with the top of the blade level with the surface of wash solution when 4 L of the wash solution is added to the sink. The blade is mounted on a vertical axis of length 85 mm. The top of the vertical axis is mounted to a second axis at an angle of 60° to the vertical, the second axis being connected to a rotation device such that the blade rotates in a plane tilted 30° from the vertical position.
2. A fixed amount (4.8 g) of the test composition is dispensed through a plastic pipette at a flow rate of 0.67 mL/sec at a height of 37 cm above the bottom surface of a sink having dimension of circa 300 min diameter and circa 300 mm height), into a stream of water of water hardness: 15 gpg and temperature 35° C. that is filling up the sink at a flow rate of 8 L/min from a tap having an M24 perlator (aerator) and a constant water pressure of 4 bar, so that 4 L of resulting wash solution is delivered to the wash basin, having a detergent concentration of 0.12 wt %. Dispensing of the test composition is started 1 second after the start of dispensing of the water stream.
3. An initial suds volume generated (measured from the average height of the foam in the sink surface and expressed in cm³ of foam (i.e. suds volume)) is recorded immediately after the end of filling.
4. The wash solution is agitated using the blade, rotating continually for 20 revolutions at 85 RPM. A fixed amount (6 mL) of a greasy or particulate soil (see Tables 1 and 2 below) is injected into the middle of the sink during the 10th rotation of the blade, such that there are 10 revolutions of the blade after addition of the soil.
5. Another measurement of the total suds volume is recorded immediately after end of blade rotation.
6. Steps 4-5 are repeated such that there is a 3 minute interval between soil additions, until the measured total suds volume reaches a minimum level of 400 cm³. The amount of added soil that is needed to arrive at the 400 cm³ level is considered as the suds mileage for the test composition.
7. Each test composition is tested 4 times per testing condition (i.e., water temperature, composition concentration, water hardness, soil type) and the average suds mileage is calculated as the average of the 4 replicates.
8. The Suds Mileage Index is calculated by comparing the average mileage of the test composition sample versus the reference composition sample. The calculation is as follows:

$$Suds Mileage Index = \frac{\begin{matrix}Average number of soil additions \\ of test composition\end{matrix}}{\begin{matrix}Average number of soil additions \\ of reference composition\end{matrix}} \times 100$$

Soil compositions are produced through standard mixing of the components described in Tables 1 and 2.

TABLE 1
Greasy Soil

| Ingredient | Weight % |
|---|---|
| Crisco Oil | 12.730% |
| Crisco shortening | 27.752% |
| Lard | 7.638% |
| Refined Rendered Edible | 51.684% |
| Beef Tallow | |
| Oleic Acid, 90% (Techn) | 0.139% |
| Palmitic Acid, 99+% | 0.036% |
| Stearic Acid, 99+% | 0.021% |

TABLE 2
Particulate Soil

| Ingredient | Weight % |
|---|---|
| Zwan Flemish Carbonades | 22.67 |
| Beaten Eggs | 4.78 |
| Smash Instant Mash Potato | 9.26 |
| McDougall's Sponge Mix | 3.30 |
| Milk UHT Full Cream | 22.22 |
| Bisto Gravy Granules | 1.30 |
| Mazola ® Pure Corn Oil | 9.29 |
| Demineralized water | 26.32 |
| Sodium Benzoate | 0.42 |
| Potassium Sorbate | 0.42 |

### EXAMPLE

### Example 1

The efficacy of poly(1,3-propyleneglycol) in cleaning compositions of the present invention for maintaining suds volume in the presence of greasy or particulate soil was assessed for a detergent composition according to the invention (Inventive Example 1), comprising poly(1,3-propyleneglycol), and a comparative detergent composition (Example A) not comprising poly(1,3-propyleneglycol).

TABLE 3
Inventive and Comparative Compositions

| | Inventive | Comparative |
|---|---|---|
| As 100% active | Example 1 | Example A |
| C12-13AE0.6S (Avg. | 19.6% | 19.6% |
| branching: 37.84%) | | |
| C12-14 dimethyl amine oxide | 6.5% | 6.5% |
| Neodol 91/8 | 1% | 1% |
| poly(1,3-propyleneglycol) | 2% | — |
| (Velvetol H500 - MW 500) | | |
| Ethanol | 2.4% | 2.4% |
| NaCl | 0.7% | 0.7% |
| Alkoxylated polyethyleneimine | 0.23% | 0.23% |
| (PEI600EO24PO16) | | |
| poly(1,2-propyleneglycol) | 0.85% | 0.85% |
| (MW2000) | | |
| Water + Minor ingredients | to 100% | to 100% |
| (perfume, dye, preservatives) | | |
| pH (after NaOH trimming) | 9.0 | 9.0 |

### Test Results: Suds Mileage of Inventive and Comparative Compositions

The Suds Mileage Index results of the test are summarized in Table 4, using the composition of Comparative Example A as the reference. From the higher Suds Mileage Index value, it can be seen that the addition of poly(1,3-propyleneglycol) results in improved suds-mileage, both in the presence of greasy and particulate soil.

TABLE 4
Suds Mileage Index Inventive and
Comparative Compositions

| | Inventive | Comparative |
|---|---|---|
| | Composition 1 | Composition 1 |
| Suds Mileage Index | 112 | 100 |
| (Greasy soil) | | |
| Suds Mileage Index | 117 | 100 |
| (Particulate soil) | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid hand dishwashing cleaning composition comprising:
a. from about 5% to about 50% by weight of the total composition of a surfactant system, wherein the surfactant system comprises:
i) an anionic surfactant selected form the group consisting of: alkyl sulfate, alkyl alkoxy sulfate, and mixtures thereof; and
ii) a co-surfactant selected from the group consisting of an amphoteric surfactant, a zwitterionic surfactant and mixtures thereof; and
b. from about 0.01% to about 10% by weight of the composition of poly(1,3-propyleneglycol).

2. The composition according to claim 1, wherein the composition comprises from about 0.1% to about 5.0% by weight of the composition of the poly(1,3-propyleneglycol).

3. The composition according to claim 2, wherein the composition comprises from about 0.25% to about 4.0% by weight of the composition of the poly(1,3-propyleneglycol).

4. The composition according to claim 1, wherein the poly(1,3-propyleneglycol) has a weight average molecular weight of greater than about 150 Da to less than about 3000 Da.

5. The composition according to claim 4, wherein the poly(1,3-propyleneglycol) has a weight average molecular weight of from greater than about 250 Da to less than about 1,500 Da.

6. The composition according to claim 1, wherein the liquid hand dishwashing cleaning composition comprising from about 8% to about 45% by weight of the total composition of the surfactant system.

7. The composition according to claim 6, wherein the liquid hand dishwashing cleaning composition comprising from about 15% to about 40% by weight of the total composition of the surfactant system.

8. The composition according to claim 1, wherein the surfactant system comprises from about 60% to about 90% by weight of the surfactant system of the anionic surfactant.

9. The composition according to claim 1, wherein the anionic surfactant has a weight average degree of branching of more than about 10%.

10. The composition according to claim 9, wherein the anionic surfactant has a weight average degree of branching of more than 20%.

11. The composition according to claim 9, wherein the anionic surfactant comprises at least about 5% by weight of the branched alkyl sulfate anionic surfactant, of branching on the C2 position.

12. The composition according to claim 11, wherein the anionic surfactant comprises at least about 10% by weight of the branched alkyl sulfate anionic surfactant, of branching on the C2 position.

13. The composition according to claim 1, wherein the anionic surfactant comprises at least one alkyl alkoxy sulfate, and wherein the at least one alkyl alkoxy sulfate has an average degree of alkoxylation of less than about 5.

14. The composition according to claim 12, wherein the at least one alkyl alkoxy sulfate has an average degree of alkoxylation of more than about 0.5 and less than about 2.

15. The composition according to claim 1, wherein the weight ratio of the anionic surfactant to the co-surfactant is from about 1:1 to about 8:1.

16. The composition according to claim 1, wherein the co-surfactant is an amine oxide surfactant.

17. The composition according to claim 15, wherein the amine oxide surfactant is selected from the group consisting of: alkyl dimethyl amine oxide, alkyl amido propyl dimethyl amine oxide, and mixtures thereof.

18. The composition according to claim 1, further comprising ethoxylated vegetable oil having an average degree of ethoxylation of from about 5 to about 50.

19. The composition according to claim 1, further comprising from about 0.05% to about 2% by weight of the total composition of an amphiphilic alkoxylated polyalkyleneimine and mixtures thereof, wherein the amphiphilic alkoxylated polyalkyleneimine is an alkoxylated polyethyleneimine polymer comprising a polyethyleneimine backbone having a weight average molecular weight range of from about 100 to about 5,000, and the alkoxylated polyethyleneimine polymer comprises the following modifications:
i) one or two alkoxylation modifications per nitrogen atom, dependent on whether the modification occurs at an internal nitrogen atom or at an terminal nitrogen atom, in the polyethyleneimine backbone, the alkoxylation modification consisting of the replacement of a hydrogen atom on by a polyalkoxylene chain having an average of about 1 to about 50 alkoxy moieties per modification, wherein the terminal alkoxy moiety of the alkoxylation modification is capped with hydrogen, a C1-C4 alkyl or mixtures thereof;
ii) a substitution of one C1-C4 alkyl moiety and one or two alkoxylation modifications per nitrogen atom, dependent on whether the substitution occurs at an internal nitrogen atom or at an terminal nitrogen atom, in the polyethyleneimine backbone, the alkoxylation modification consisting of the replacement of a hydrogen atom by a polyalkoxylene chain having an average of about 1 to about 50 alkoxy moieties per modification wherein the terminal alkoxy moiety is capped with hydrogen, a C1-C4 alkyl or mixtures thereof; or
iii) a combination thereof; and
wherein the alkoxy moieties are selected from ethoxy (EO), propoxy (PO), butoxy (BO), and mixtures thereof, with the proviso that the alkoxy moieties do not solely comprising ethoxy units.

20. A method of manually washing dishware comprising the steps of: delivering a composition according to claim 1 to a volume of water to form a wash solution and immersing the dishware in the solution.
